(19) United States
(12) Patent Application Publication
(10) Pub. No.: US 2024/0173584 A1
(43) Pub. Date: May 30, 2024

(54) FIRE EXTINGUISHERS

(71) Applicant: Kidde Graviner Limited, Solihull, (GB)

(72) Inventor: Robert Dunster, Slough (GB)

(21) Appl. No.: 18/522,190

(22) Filed: Nov. 28, 2023

(30) Foreign Application Priority Data
Nov. 30, 2022 (EP) 22210689.0

(51) Int. Cl. A62C 13/76; A62C 13/70

(52) U.S. Cl. CPC A62C 13/76; A62C 13/70

(57) ABSTRACT

An adapter for a fire extinguisher includes a cylinder which has an internal volume for storage of an extinguishing agent and a neck through which the internal volume may be accessed, a release valve, and a dip tube. The adapter defines a first flow path through the adapter for the extinguishing agent during introduction or charging of the extinguishing agent into the internal volume of the cylinder. The adapter at least partially defines or accommodates a second flow path for the extinguishing agent through the adapter during discharging of the fire extinguisher of which the adapter is part. The first and second flow paths are different.

### CROSS-REFERENCE TO RELATED APPLICATION(S)

The present application claims priority to European Application No. 22210689.0 filed on Nov. 30, 2022, the contents of which are incorporated by reference herein in their entirety.

### BACKGROUND

This disclosure relates to fire extinguishers, and in particular pressurized fire extinguishers that include a dip tube.

Fire extinguishers with a dip tube typically also include a cylinder that may be pressurized, an extinguishing agent that is stored in the cylinder until the fire extinguisher is discharged, typically to fight a fire, and a valve that actuates and/or controls the discharge of the fire extinguisher. The dip tube is attached to the release valve and held in a desired position within the internal volume of the cylinder by the dip tubes attachment to the release valve. The desired position is typically one in which the dip tube is not in contact with the walls of the cylinder. The use of a dip tube both assists in achieving a desired performance when the fire extinguisher is discharged, and in maximising the volume of extinguishing agent that the fire extinguisher discharges.

### SUMMARY

According to a first aspect of the present disclosure there is provided an adapter for a fire extinguisher comprising a cylinder which has an internal volume for the storage of an extinguishing agent and a neck through which the inside of the cylinder may be accessed, a release valve, and a dip tube. The adapter defines a first flow path through the adapter for the extinguishing agent for use when the extinguishing agent is introduced or charged into the internal volume of the cylinder. The adapter at least partially defines or accommodates a second flow path for the extinguishing agent through the adapter for use when the fire extinguisher of which the adapter is part is discharged. The first and second flow paths are different.

The second flow path is accommodated by the adapter when a part of the dip tube and part of the release valve are engaged with and within a bore or passage defined by the adapter and the second flow path is defined by those parts of the dip tube and release valve.

In an embodiment of the above embodiment, the adapter is so configured that the first flow path is not disrupted if the dip tube is engaged with the adapter and the dip tube is blocked.

In an embodiment of any of the above embodiments, the adapter is so configured that the first flow path does not include the extinguishing agent passing from the adapter and flowing through the dip tube.

In an embodiment of any of the above embodiments, the first flow path has a lower resistance to the flow of extinguishing agent than the second flow path.

It is known that the conditions under which the extinguishing agent is introduced into the internal volume of a fire extinguisher (when the fire extinguisher is being prepared for deployment to a position in which the fire extinguisher will sit until it is used, also termed discharged) are different from the conditions when the fire extinguisher is discharged. In particular, the internal pressure of the extinguishing agent is significantly higher when the fire extinguisher is discharged than when the extinguishing agent is being introduced into the cylinder. Known Fire extinguishers, once the release valve and dip tube have been engaged with the cylinder include only one flow path for the extinguishing agent.

An advantage of the present disclosure is that the configuration of the adapter allows for the difference in the conditions under which the extinguishing agent follows the first flow path and the second flow path. And in particular that the extinguishing agent will flow along the second flow path when the fire extinguisher is discharged but not when the cylinder is being charged with extinguishing agent.

More specifically, the extinguishing agent will flow along a dip tube when the fire extinguisher is discharged as a result of the internal pressure of the extinguishing agent, whereas attempts to charge the cylinder with extinguishing agent through a dip tube will, at best, lead to very slow charging of the cylinder with extinguishing agent, and at worst the dip tube will become blocked because the extinguishing agent is not at sufficient pressure to force it along the dip tube.

For non-liquid extinguishing agents, for example dry powder extinguishing agents, it is not desirable or in some circumstances possible to introduce a dip tube into the extinguishing agent once the extinguishing agent has been placed into the cylinder. This is because of the risk of damage to the dip tube and/or the difficulty of accurately locating the dip tube within the cylinder. This risk and difficulty is enhanced when a non-linear dip tube is to be used in the fire extinguisher. The adapter of the present disclosure is advantageous because it allows the cylinder to be charged with extinguishing agent whilst the dip tube is in the cylinder and connected to the adapter and located in the desired position for the dip tube within the cylinder.

In an embodiment of the above embodiment, the adapter comprises a cylinder engagement element, a through bore and at least one filling hole. The cylinder engagement element is configured to engage with the neck of a cylinder. The adapter defines the through bore, and the through bore extends between a first mouth opening through a first portion of the adapter and a second mouth opening through a second portion of the adapter. The adapter is so configured that when the adapter is engaged with the cylinder the first mouth of the through bore opens outside the cylinder and the second mouth opens within the cylinder or the neck of the cylinder. The first mouth of the through bore is configured to engage with the release valve, and the second mouth is configured to engage with a dip tube. Each filling hole extends between a first hole end which is a hole in a surface that defines the through bore, and a second hole end. When the adapter is engaged with the cylinder the second hole end is located both in a part of a surface of the adapter that is within the cylinder or the neck of the cylinder, and in a position from which there is a flow path for extinguishing agent from the second hole end to the internal volume of the cylinder.

It is to be understood that in this description when a first element is described as “engaged with” a second element this indicates that the elements are physically interlocked with each other and that the interlocking has continued until further performance of the action that caused the interlocking has ceased to be possible. For example if the first element includes an external screw thread and the second element includes a compatible internal screw thread, the elements are engaged with each other when the screw threads have been screwed together until further screwing together of the screw threads was no longer possible.

In an embodiment of the above embodiment, the adapter is configured to engage with a cylinder which is so configured that the neck of the cylinder extends in an axial direction away from the outer surface of the cylinder, the neck defines a hollow passage extending between a free end of the neck and the internal volume of the cylinder, and the neck comprises an adapter engagement element. In some embodiments the adapter engagement element has the form of an internal screw thread. In some other embodiments the adapter engagement element has the form of an external screw thread.

In an alternative embodiment of the above embodiment, the adapter is configured to engage with a cylinder which is so configured that the neck of the cylinder extends in an axial direction into the internal volume of the cylinder, the neck defines a hollow passage extending between the internal volume of the cylinder and the outer surface of the cylinder, and the neck comprises an adapter engagement element. In some embodiments the adapter engagement element has the form of an internal screw thread.

In an alternative embodiment of the above embodiment, the adapter is configured to engage with a cylinder which is so configured that the neck of the cylinder extends between the inner surface of the cylinder and the outer surface of the cylinder, and the neck comprises an adapter engagement element. In some embodiments the adapter engagement element is an internal screw thread.

An advantage of the adapter of the present disclosure is that without changing the functioning or dimensions of the remaining elements of the adapter, the configuration of the adapter can be chosen to allow the adapter to be engaged with any pre-existing fire extinguisher cylinder. This allows the adapter of the present disclosure to be retro-fitted to pre-existing fire extinguisher cylinders. This is advantageous because it allows the adapter to be used with locally approved types of cylinders, and existing cylinders with minimal engineering changes to the adapter.

In an embodiment of any of the above embodiments, the second mouth is so configured that the engagement between the adapter and the dip tube is a sliding fit and the adapter comprises a lock element configured to lock the dip tube in position relative to the adapter. The dip tube is a sliding fit within the second mouth.

In an embodiment of any of the above embodiments, the through bore of the adapter is linear.

In an embodiment of any of the above embodiments, the adapter comprises a stop element, and the stop element defines a part of the second mouth that is furthest from the second portion of the adapter. The stop element is configured to prevent more than a predetermined length of a first end of the dip tube from being inserted into the second mouth.

In an embodiment of the above embodiment, the stop element has the form of an annular ring.

In an embodiment of any of the above embodiments, the adapter is so configured that the first hole end of each filling hole is closed when the release valve is engaged with the adapter. The closure of the first hole end of each filling hole occurs as a result of part of the release valve blocking or closing the first end hole or by the release valve causing the first hole end to open into a closed volume within the through bore of the adapter. A closed volume is one in which the only flow path into or out of the volume is through a filling hole. The effect of the closure of the filling hole is that when the fire extinguisher of which the adapter is a part is discharged, the extinguishing agent and/or any propellent gas in which the extinguishing agent may be entrained cannot leave the internal volume of the cylinder via the filling hole.

In an embodiment of any of the above embodiments, the first portion of the adapter comprises one or more first indexing elements, the second portion of the adapter comprises one or more second indexing elements, and the first and second indexing elements are aligned with each other. A first and second index mark are aligned with each other when the radial direction from the central axis of the first mouth to the first index mark is the same as the radial direction from the central axis of the second mouth to the second index mark.

In an embodiment of any of the above embodiments, the adapter comprises a seal element, and the seal element is positioned in the through bore between the second mouth and the first hole end of the filling hole or holes.

In an embodiment of any of the above embodiments, there are one, two, three or four filling holes.

In an alternative embodiment of the above embodiment, there are five or more filling holes.

The minimum size and number of the filling holes is determined by the rate of flow of extinguishing agent that can be achieved through the filling holes and by the need for the filling holes not to become blocked by the extinguishing agent when extinguishing agent is being charged or introduced into the internal volume at the pressures used for the introduction of the extinguishing agent.

According to a second aspect of the present disclosure there is provided a fire extinguisher comprising a cylinder having a neck through which the inside of the cylinder may be accessed, a release valve, an adapter according to the first aspect of the present disclosure, and a dip tube.

In an embodiment of any of the above embodiments, the release valve comprises an adapter engagement element and a discharge passage. The discharge passage is configured to be in fluid communication with the through bore of the adapter when the release valve is engaged with the adapter, and a part of the length of the discharge passage is surrounded by the adapter engagement element. The first mouth of the adapter is configured to engage with the valve engagement element of the release valve.

In an embodiment of any of the above embodiments, the dip tube comprises one or more entry holes; and the dip tube is so configured that the dip tube may be fixed to the adapter in an orientation relative to the adapter such that the one or more entry holes are in a predetermined part of the internal volume of the cylinder when the adapter is engaged with the cylinder.

The entry holes are configured to allow the extinguishing agent and any propellent gas into the dip tube when the fire extinguisher in which the dip tube is located is discharged.

In an embodiment of any of the above embodiments, the through bore in the adapter is linear, and the release valve comprises a valve dip tube. The valve dip tube extends from the discharge passage of the release valve towards the second mouth of the adapter when the release valve is engaged with the adapter. The valve dip tube is linear, dimensioned to be a loose or sliding fit within the through bore of the adapter, and sufficiently long that when the release valve is engaged with the adapter the valve dip tube closes the first hole end of the or each filling hole.

In an embodiment of any of the above embodiments, the adapter comprises a seal element, and the seal element is positioned in the through bore between the second mouth of the adapter and the first hole end of the or each filling hole. When the release valve is engaged with the adapter the seal element forms a pressure tight seal between the valve dip tube and the surface defining the through bore.

In an embodiment of any of the above embodiments, the adapter engagement element of the release valve is so configured that when the release valve is engaged with the adapter the adapter engagement element closes the first hole end of each filling hole.

In an embodiment of any of the above embodiments, the adapter comprises a seal element, and the seal element is positioned in the through bore between the second mouth of the adapter and the first hole end of the or each filling hole. When the release valve is engaged with the adapter the seal element forms a pressure tight seal between the adapter engagement element of the release valve and the surface defining the through bore.

In an embodiment of any of the above embodiments, the fire extinguisher comprises an extinguishing agent in the form of a dry powder.

According to a third aspect of the present disclosure there is provided a method of charging a fire extinguisher comprising:
providing a cylinder with a neck through which the inside of the cylinder may be accessed, an adapter according to the first aspect of the present disclosure, a dip tube, and a release valve;
engaging a first end of the dip tube with the second mouth of the through bore of the adapter;
inserting a second end of the dip tube through the neck and engaging the adapter with the neck of the cylinder;
introducing a predetermined amount of extinguishing agent into the cylinder;
engaging the release valve with the first mouth of the through bore of the adapter with the result that the first hole end of each filling hole in the adapter is closed; and
pressurizing the cylinder through the release valve.

The extinguishing agent may be introduced into the cylinder by any appropriate method including, but not limited to, using a funnel or a pumped source of extinguishing agent.

In an embodiment of any of the above embodiments, the extinguishing agent is a dry powder extinguishing agent.

In an embodiment of any of the above embodiments, the method comprises
providing a cylinder with a predetermined vertically lowest part of the cylinder when the fire extinguisher is orientated for use;
providing an adapter in which the first portion of the adapter comprises one or more first indexing elements, the second portion of the adapter comprises one or more second indexing elements, and the first and second indexing elements are aligned with each other;
providing a dip tube comprising one or more entry holes, in which the dip tube is so configured that the one or more entry holes may be in the predetermined vertically lowest part of the cylinder when the fire extinguisher is orientated for use;
before engaging a first end of the dip tube with the second mouth of the through bore of the adapter, the adapter is engaged with the neck of the cylinder and the orientation of the adapter relative to the predetermined vertically lowest part of the cylinder when the fire extinguisher is orientated for use is noted using the indexing element of the first portion; and
when engaging the first end of the dip tube with the second mouth of the through bore of the adapter the indexing elements on the second portion of the adapter are used to orientate the dip tube so that once the adapter is engaged with the neck of the cylinder the entry holes of the dip tube are in the predetermined vertically lowest part of the cylinder when the fire extinguisher is orientated for use.

The apparatus of the first and second aspects of the present disclosure can include one or more, or all, of the features described above as appropriate. The method of the third aspect of the present disclosure can include one or more, or all, of the features described above as appropriate.

### BRIEF DESCRIPTION OF THE DRAWINGS

The present disclosure will be further described and explained by way of example with reference to the accompanying drawings in which:

FIG. 1 shows a schematic embodiment of a fire extinguisher according to the present disclosure;

FIG. 2 shows a first schematic detail of a part of the fire extinguisher of FIG. 1;

FIG. 3 shows a second schematic detail of a part of the fire extinguisher of FIG. 1;

FIG. 4 shows a third schematic detail of a part of the fire extinguisher of FIG. 1;

FIG. 5 shows a schematic cross-section of the fire extinguisher of FIG. 1;

FIG. 6 shows a fourth schematic detail of a part of the fire extinguisher of FIG. 1; and

FIG. 7 shows a schematic cross-section of the fire extinguisher of FIG. 1 when it is being filled with an extinguishing agent.

### DETAILED DESCRIPTION

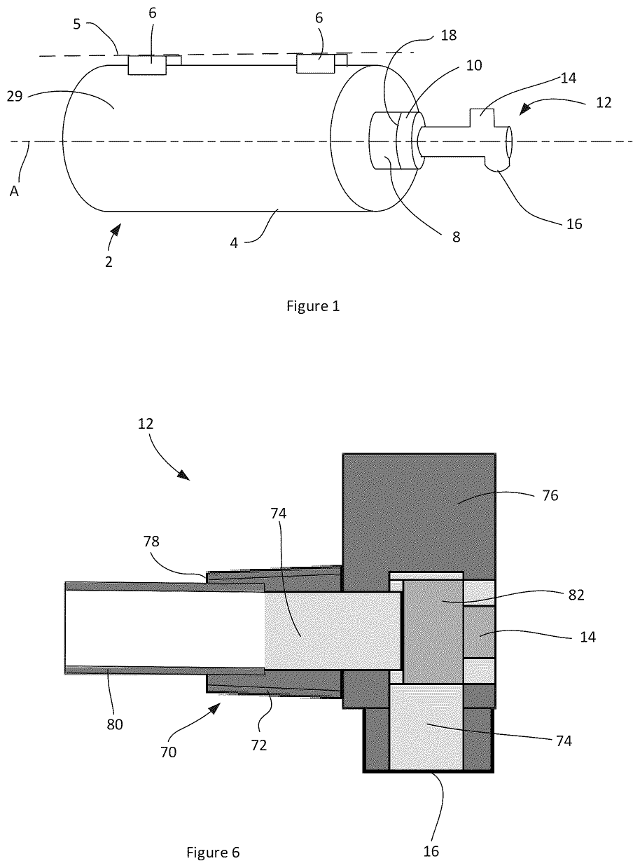

With reference to FIG. 1, a fire extinguisher 2 comprises a cylinder 4 to which a pair of mounting brackets 6 are attached. The cylinder 4 has a cylindrical hollow neck 8 through which the inside of the cylinder 4 may be accessed. The cylinder 4 and neck 8 have a common central axis A.

The fire extinguisher 2 is configured to be attached vertically beneath a horizontal surface 5, for example a ceiling. The mounting brackets 6 are used to attach the fire extinguisher 2 to the ceiling 5. In alternative non-illustrated embodiments the fire extinguisher may be alternatively orientated. For example the cylinder may be orientated so that the neck of the cylinder is the vertically uppermost. The possible orientations are limited by a requirement that the release valve is vertically above the dip tube.

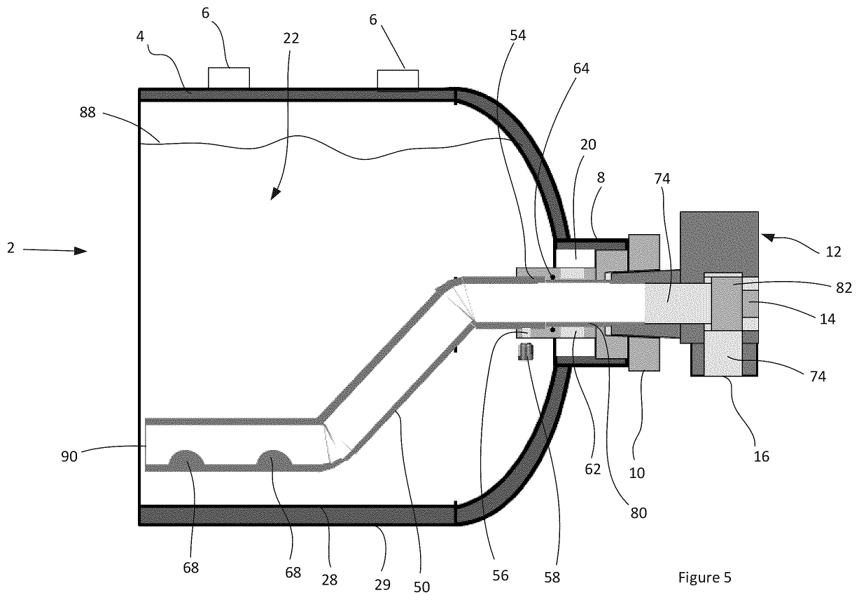

Engaged with the neck 8 is an adapter 10, and engaged with the adapter 10 is a release valve 12. The release valve 12 includes a valve actuator 14 and a discharge mouth 16. The valve actuator 14 may be a known form of fire extinguisher actuator, for example, but without limitation, the valve actuator 14 may be an actuator that causes the fire extinguisher 2 to discharge an extinguishing agent 88 stored in the cylinder 4 when the actuator 14 reaches a predetermined temperature. The extinguishing agent 88 (see FIG. 5) is discharged through the discharge mouth 16.

The cylinder 4 is a cylinder suitable for use as part of a fire extinguisher. A pair of mounting brackets 6 are attached to the outer surface 29 of the cylinder 4.

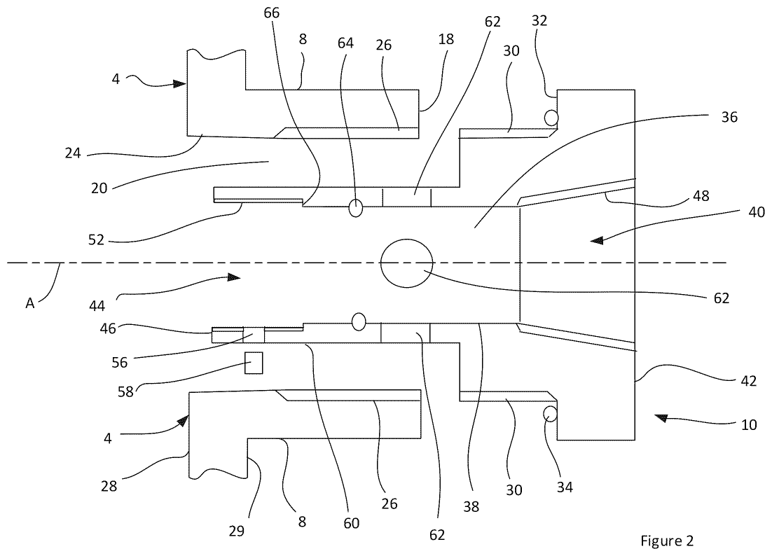

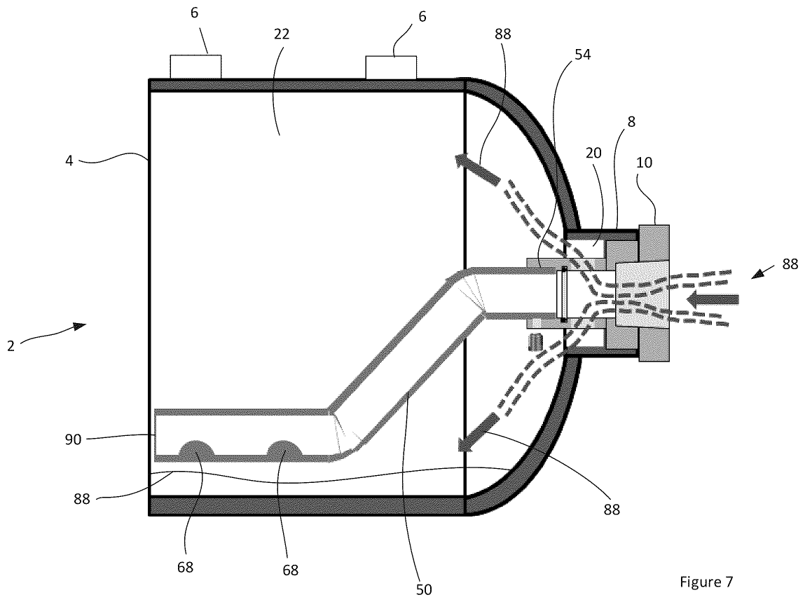

The cylinder 4 has a cylindrical hollow neck 8. The neck 8 defines a hollow passage 20 that extends from the outer end 18 of the neck 8 to the inner surface 28 of the cylinder 4 (see FIG. 2). Inner surface 28 substantially defines the internal volume 22 of the cylinder 4 (see FIGS. 5 and 7).

With reference to FIGS. 2 and 5, greater detail of the neck 8, adapter 10 and the inside of the cylinder 4 are shown. The neck 8 extends in an axial direction away from the cylinder 4 and a radially inner surface 24 of the neck 8 defines the passage 20. A portion of the inner surface 24 extending from the outer end 18 towards the cylinder 4 is an adapter engagement element 26 which has the form of an internal thread.

In some non-illustrated embodiments of the cylinder 4 the neck 8 may extend between the inner surface 28 of the cylinder 4 and the outer surface 29 of the cylinder 4 and be defined by the portion of the cylinder 4 that surrounds the passage 20. In some non-illustrated embodiments of the cylinder 4 the adapter engagement element 26 may extend for the whole of the distance from the outer end of the neck to the internal surface of the cylinder. In some other non-illustrated embodiments of the cylinder 4 the neck 8 may have a smooth inner surface 24 and some or all of the radially outer surface of the neck 8 may be an adapter engagement element with the form of an external screw thread.

The adapter 10 includes a cylinder engagement element 30 in the form of an external thread. The cylinder engagement element 30 is configured to engage with the adapter engagement element 26 of the cylinder 4. This is advantageous because different adapters 10 according to the present disclosure can be configured to engage with different configurations of cylinder 4/neck 8 without changing the other features of the adapter 10. The cylinder engagement element 30 and adapter engagement element 26 are so configured that screwing them together until a stop surface 32 of the adapter 10 abuts the outer end 18 of the neck 8 forms a pressure tight or substantially pressure tight engagement between the neck 8 and the adapter 10. In some embodiments a suitable pressure resistant seal 34 may be located between the stop surface 32 and outer end 18. The adapter 10 has a central axis which is co-axial with central axis A when the adapter 10 is engaged with the cylinder 4.

The adapter 10 also includes a linear through bore 36 defined by a bore surface 38 of the adapter 10. The through bore 36 has a circular cross-section in the plane perpendicular to central axis A, and extends between a first mouth opening 40 through a first portion 42 of the adapter 10 and a second mouth 44 opening through a second portion 46 of the adapter 10. When the cylinder engagement element 30 and adapter engagement element 26 of the cylinder 4 are engaged with each other the first portion 42 is in the atmosphere surrounding the cylinder 4 and the second portion 46 is within the passage 20 or internal volume 22. The first and second mouths 40, 44 each have a central axis which is co-axial with central axis A when the adapter 10 is engaged with the cylinder 4.

The first mouth 40 is configured to engage with the release valve 12 and includes a valve engagement element 48 in the form of a conical internal thread. The valve engagement element 48 decreases in diameter from the surface of the first portion 42 of the adapter 10 to the diameter of the through bore 36.

The second mouth 44 is configured to engage with a dip tube 50, and includes an axially extending length of an inner surface 52 of increased diameter relative to the through bore 36. The inner surface 52 is in the form of a screw thread which is configured to be threadedly connected to a screw thread (not shown) formed in a first end portion 54 of the dip tube 50.

In an alternative non-illustrated embodiment, the increased diameter of the second mouth/inner surface of the second mouth is such that a first end portion of the dip tube is a sliding fit within the inner surface.

The maximum amount of the first end portion 54 of the dip tube 50 that can be inserted into the second mouth 44 is governed by a stop ring 66 which is formed at the edge of the increased diameter surface 52. A lock element in the form of an internally threaded bore 56 and grub screw 58 are provided to lock the dip tube 50 in position relative to the adapter 10. The threaded bore 56 extends through the adapter 10 from an outer surface 60 to the inner surface 52. The grub screw 58 is adapted to engage with the thread of the threaded bore 56 and can be tightened so that the grub screw 58 bears on a part of the end portion 54 of the dip tube to fix or lock the position and orientation of the dip tube 50 relative to the adapter 10.

Extending through the adapter 10 between the bore surface 38 and outer surface 60 are four filling holes 62 (of which only three are shown). The filling holes 62 are of a size such that extinguishing agent 88 may flow through the filling holes without blocking or clogging the filling holes 62. The adapter 10 is so configured that the outer surface 60 of the adapter 10 is spaced from the inner surface 24 of the neck 8 by a sufficient distance that the extinguishing agent 88 can flow along the portion of the passage 20 between the outer surface 60 and inner surface 24 and into the internal volume 22 without blocking or clogging that part of the passage 20.

Positioned between the end of the second mouth 44 closest to the first mouth 40 and the filling holes 62 is an annular seal element 64.

With reference to FIG. 3, an end view of the illustrated embodiment of the adapter 10 shows the first mouth 40 and the first portion 42. The first portion 40 includes a plurality of first index marks 84. The first index marks 84 are each separated by an angle of 45 degrees around the central axis of the first mouth.

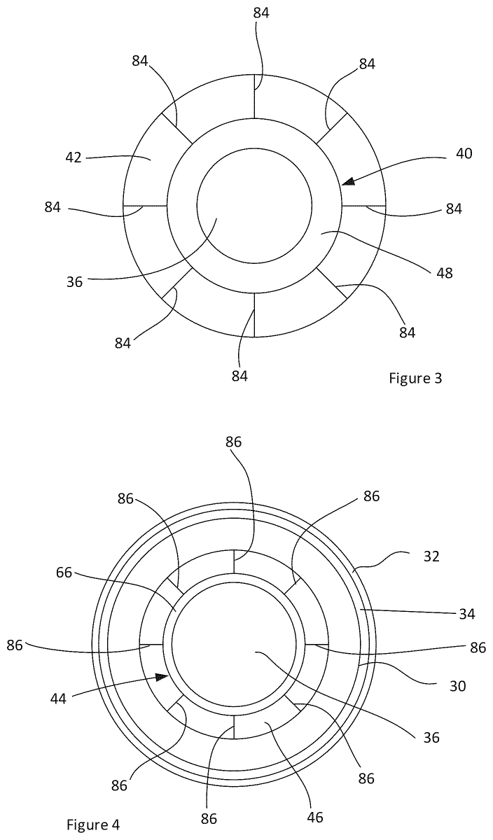

With reference to FIG. 4, a second end view of the illustrated embodiment of the adapter 10 shows the second mouth 44 and the second portion 46. The second portion 46 includes a plurality of second index marks 86. The second index marks 86 are each separated by an angle of 45 degrees around the central axis of the second mouth.

With reference to FIGS. 3 and 4, the first and second index marks 84, 86 are aligned with each other. A first and second index mark 84, 86 are aligned with each other when the radial direction from the central axis of the first mouth to the first index mark 84 is the same as the radial direction from the central axis of the second mouth to the second index mark 86.

With reference to FIG. 5, the dip tube 50 is longitudinally extending and so configured that the portion of the dip tube that includes the entry holes 68 is closer to the part of the cylinder 4 diametrically opposite to the mounting brackets 6 than other parts of the cylinder 4 when correctly orientated relative to the adapter 10. This has the effect of maximising the quantity of extinguishing agent 88 that can enter the dip tube 50 via the entry holes 68 when the fire extinguisher 2 is discharged. The entry holes 68 are of sufficiently large dimensions that extinguishing agent may enter the dip tube 50 without becoming blocked by the extinguishing agent when the internal volume 22 is pressurized to a predetermined pressure. The predetermined pressure is a pressure that will cause the fire extinguisher to perform as it is designed to perform.

With reference to FIGS. 2 and 6, the release valve 12 includes an adapter engagement element 70 and a discharge passage 74. The adapter engagement element 70 includes an external conical thread 72 which is configured to be engageable with the valve engagement element 48 of the first mouth 40 of the adapter 10.

The adapter engagement element 70 extends from a main body 76 of the release valve 12 to an engagement end 78 and the diameter of the conical thread decreases from the intersection of the adapter engagement element 70 with the main body 76 to the engagement end 78.

The engagement end 78 of the adapter engagement element 70 is adapted to receive a linear valve dip tube 80. The valve dip tube 80 projects into the through bore 36 of the adapter and past the seal element 64 when the release valve 12 is engaged with the adapter 10. The valve dip tube 80 is so dimensioned that the open ends of the filling holes 62 in the bore surface 38 are closed by the valve dip tube 80. The seal element 64 forms a pressure tight seal between the valve dip tube 80 and the bore surface 38. If the closure of the filling holes 62 by the valve dip tube 80 is not pressure tight, a closed volume is formed between the seal element 64, bore surface 38, valve engagement element 48/adapter engagement element 70 and valve dip tube 80.

The main body of the release valve 12 defines a part of the discharge passage 74 that fluidly connects the part of the discharge passage 74 surrounded by the adapter engagement element 70 and the discharge mouth 16. A valve element 82 which is controlled by the actuator 14 controls the flow of extinguishing agent (not shown in FIGS. 2 and 6) along the discharge passage 74.

The release valve 12 also includes a known system (not shown) that allows the cylinder internal volume 22 to be pressurized, once the adapter 10 is engaged with the cylinder 4, and the release valve 12 is engaged with the adapter 10. The pressurization may be with nitrogen or other gases commonly used for fire extinguishers.

With reference to FIG. 7, a method of charging a fire extinguisher 2 with an extinguishing agent 88 includes providing a cylinder 4 with a neck 8 that defines a passage 20 through which the internal volume 22 inside of the cylinder 4 may be accessed. The cylinder 4 is selected for its ability to withstand the pressures and use conditions required of the fire extinguisher 2.

An adapter 10 is provided on which the first and second portions 42, 46 carry first and second indexing marks 84, 86 respectively.

Also provided is a dip tube 50 which includes one or more entry holes 68, in which the dip tube 50 is so configured that the one or more entry holes 68 may be located in the vertically lowest part of the cylinder 4 when the fire extinguisher 2 is orientated for use. The vertically lowest part of the cylinder 4 when the fire extinguisher 2 is orientated for use can be determined by reference to the position of the mounting brackets 6 on the cylinder 4 and a knowledge of where the fire extinguisher 2 is to be mounted, for example onto the underside of a ceiling 5 (see FIG. 1).

Before a first end 54 of the dip tube 50 is engaged with the second mouth 44 of the through bore 36 of the adapter 10, the adapter 10 is engaged with the neck 8 of the cylinder 4. The engagement is tightened to the level of torque that will be employed when the fire extinguisher is constructed ready for use. The orientation of the release valve 12 relative to the determined vertically lowest part of the cylinder 4 is noted using the first indexing elements 84 on the first portion 42.

The adapter 10 is next disengaged from the cylinder 4.

The first end 54 of the dip tube 50 is engaged with the second mouth 44 of the through bore 36 of the adapter 10 and the second indexing elements 86 located on the second portion 46 of the adapter 10 are used to orientate the dip tube 50. Once the dip tube 50 is correctly orientated the grub screw 58 is tightened in the threaded bore 56 to fix the orientation of the dip tube 50. The orientation is determined by the previously measured orientation of the adapter 10 relative to the cylinder 4 and has the effect that once the adapter 10 (with which the dip tube 50 is engaged) is engaged with the neck 8 of the cylinder 4 the entry holes 68 are in the determined vertically lowest part of the cylinder 4 when the fire extinguisher 2 is orientated for use.

The second end 90 of the dip tube 50 is inserted through the passage 20 in the neck 8 until the cylinder engagement element 30 of the adapter 10 and the adapter engagement element 26 of the cylinder 4 are in a position to engage with each other. The cylinder engagement element 30 and adapter engagement element 26 are then caused to engage with each other so that a pressure tight engagement is achieved.

A funnel (not shown) is engaged with the valve engagement element 48 of the first mouth 40 of the adapter 10 and a predetermined amount of extinguishing agent 88 is introduced into the cylinder 4. The extinguishing agent 88 will flow from the funnel into the through bore 36. The extinguishing agent 88 will then, pass out of the through bore 36 and into the passage 20/internal volume 22 through the filling holes 62. Depending on the nature of the extinguishing agent 88, some extinguishing agent 88 may flow along the dip pipe 50 and out of the entry holes 68 therein but the dip tube 50 may become blocked because of the low pressures used to charge the cylinder 4 with the extinguishing agent 88.

Once the cylinder 4 is fully charged with extinguishing agent 88, the funnel is disengaged from the valve engagement element 48.

The release valve 12 is next engaged with the valve engagement element 48 of the adapter 10. The engagement of the release valve 12 with the valve engagement element 48 causes the filling holes 62 to be closed or blocked with the result that when the fire extinguisher 2 is discharged the extinguishing agent 88 and any propellent gas cannot pass through the filling holes 62 forcing the extinguishing agent 88 and any propelling gas to enter the dip tube 50 through the entry holes 68 and travel along the dip tube 50.

Once the release valve 12 is engaged with the adapter 10 the cylinder 4 may be pressurized by a known technique. For example, for a fire extinguisher 2 that contains a dry powder extinguishing agent 88, pressurized nitrogen is introduced into the cylinder 4.

The release valve 12 may be so configured that it is possible to release the pressurized gas within the cylinder 4 without operating the valve element 82 so as to cause the discharge of the extinguishing agent 88. This is particularly useful if the fire extinguisher 2 needs to be serviced. Once the pressurized gas is released from the cylinder 4 the extinguishing agent 88 can be poured out of the cylinder 4 through the filling holes 62. Thereafter the adapter 10 can be disengaged from the cylinder 4. It is noted that where the extinguishing agent 88 is a dry powder and the dip tube 50 is not is not a linear dip tube this is co-axial with central axis A when the adaptor 10 is engaged with the cylinder 4, it is likely not to be possible to disengage the adapter 10 from the cylinder 4 without damage to at least the dip tube 50 whilst the extinguishing agent 88 is in the cylinder 4.

The above description is meant to be exemplary only, and one skilled in the art will recognize that changes may be made to the embodiments described without departing from the scope of the disclosure. Still other modifications which fall within the scope of the present disclosure will be apparent to those skilled in the art, in light of a review of this disclosure.

Various aspects of the method and apparatus disclosed in the various embodiments may be used alone, in combination, or in a variety of arrangements not specifically discussed in the embodiments described above. This disclosure is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. An adapter for a fire extinguisher comprising a cylinder which has an internal volume for storage of an extinguishing agent and a neck through which the internal volume may be accessed, a release valve, and a dip tube, wherein:
the adapter defines a first flow path through the adapter for the extinguishing agent during introduction or charging of the extinguishing agent into the internal volume of the cylinder;
the adapter at least partially defines or accommodates a second flow path for the extinguishing agent through the adapter during discharging of the fire extinguisher of which the adapter is part; and
the first and second flow paths are different.

2. The adapter according to claim 1, wherein:
the adapter comprises a cylinder engagement element, a through bore and at least one filling hole;
the cylinder engagement element is configured to engage with the neck of the cylinder;
the adapter defines the through bore;
the through bore extends between a first mouth opening through a first portion of the adapter and a second mouth opening through a second portion of the adapter;
the adapter is so configured that when the adapter is engaged with the cylinder a first mouth of the through bore opens outside the cylinder and a second mouth of the through bore opens within the cylinder or the neck of the cylinder;
the first mouth is configured to engage with a release valve;
the second mouth is configured to engage with a dip tube; and
each filling hole extends between a first hole end which is a hole in a surface that defines the through bore and a second hole end, wherein when the adapter is engaged with the cylinder, the second hole end is located in a part of a surface of the adapter that is within the cylinder or the neck of the cylinder, and located in a position in which there is a flow path for extinguishing agent from the second hole end to the internal volume of the cylinder.

3. The adapter according to claim 2, wherein the second mouth is so configured that the engagement between the adapter and the dip tube is a threaded fit and the adapter comprises a lock element configured to lock the dip tube in position relative to the adapter.

4. The adapter according to claim 2, wherein the adapter is so configured that the first hole end of each filling hole is closed when the release valve is engaged with the adapter.

5. The adapter according to claim 2, wherein the first portion of the adapter comprises one or more first indexing elements, the second portion of the adapter comprises one or more second indexing elements, and the first and second indexing elements are aligned with each other.

6. The adapter according to claim 2, wherein the adapter comprises a seal element, and the seal element is positioned in the through bore between the second mouth and the first hole end of the filling hole.

7. A fire extinguisher comprising:
a cylinder having a neck through which an internal volume of the cylinder may be accessed;
a release valve;
the adapter according to claim 2; and
a dip tube.

8. The fire extinguisher according to claim 7, wherein:
the release valve comprises an adapter engagement element and a discharge passage;
the discharge passage is configured to be in fluid communication with the through bore of the adapter when the release valve is engaged with the adapter;
a part of a length of the discharge passage is surrounded by the adapter engagement element; and
the first mouth of the adapter is configured to engage with the valve engagement element of the release valve.

9. The fire extinguisher according to claim 8, wherein:
the dip tube comprises one or more entry holes; and
the dip tube is so configured that the dip tube may be fixed to the adapter in an orientation relative to the adapter such that the one or more entry holes are in a predetermined part of the cylinder when the adapter is engaged with the cylinder.

10. The fire extinguisher according to claim 8, wherein:
the through bore in the adapter is linear;
the release valve comprises a valve dip tube;
the valve dip tube extends from the discharge passage of the release valve towards the second mouth of the adapter when the release valve is engaged with the adapter; and
the valve dip tube is linear, dimensioned to be a loose or sliding fit within the through bore of the adapter, and sufficiently long that when the release valve is engaged with the adapter the valve dip tube closes the first hole end of each filling hole.

11. The fire extinguisher according to claim 8, wherein the adapter engagement element of the release valve is so configured that when the release valve is engaged with the adapter, the adapter engagement element closes the first hole end of each filling hole.

12. The fire extinguisher according to claim 10, wherein:
the adapter comprises a seal element;
the seal element is positioned in the through bore between the second mouth of the adapter and the first hole end of the filling hole; and
when the release valve is engaged with the adapter, the seal element forms a pressure tight seal between the valve dip tube or adapter engagement element and the surface defining the through bore.

13. The fire extinguisher according to claim 7, wherein the fire extinguisher comprises an extinguishing agent in the form of a dry powder.

14. A method of charging a fire extinguisher, the method comprising:
providing a cylinder with a neck through which the inside of the cylinder may be accessed, the adapter according to claim 2, a dip tube, and a release valve;
engaging a first end of the dip tube with the second mouth of the through bore of the adapter;
inserting a second end of the dip tube through the neck and engaging the adapter with the neck of the cylinder;
introducing a predetermined amount of extinguishing agent into the cylinder;
engaging the release valve with the first mouth of the through bore of the adapter so that the first hole end of each filling hole in the adapter is closed; and
pressurizing the cylinder through the release valve.

15. The method according to claim 14, wherein the extinguishing agent is a dry powder extinguishing agent.

16. The method according to claim 14, wherein:
the cylinder provided has a predetermined vertically lowest part of the cylinder when the fire extinguisher is orientated for use;
the first portion of the adapter provided comprises one or more first indexing elements, the second portion of the adapter provided comprises one or more second indexing elements, and the first and second indexing elements are aligned with each other;
the dip tube provided comprises one or more entry holes, wherein the dip tube is so configured that the one or more entry holes are located in the predetermined vertically lowest part of the cylinder when the fire extinguisher is orientated for use;
before engaging a first end of the dip tube with the second mouth of the through bore of the adapter, the adapter is engaged with the neck of the cylinder and the orientation of the adapter relative to the predetermined vertically lowest part of the cylinder when the fire extinguisher is orientated for use is noted using the indexing element of the first portion; and
when engaging the first end of the dip tube with the second mouth of the through bore of the adapter, the indexing elements on the second portion of the adapter are used to orientate the dip tube so that once the adapter is engaged with the neck of the cylinder, the entry holes are in the predetermined vertically lowest part of the cylinder when the fire extinguisher is orientated for use.
